(19) United States
(12) Patent Application Publication
(10) Pub. No.: US 2014/0293895 A1
(43) Pub. Date: Oct. 2, 2014

(54) INTERFERENCE PROCESSING FOR WIRELESS COMMUNICATION TERMINAL

(71) Applicant: INTERNATIONAL BUSINESS MACHINES CORPORATION, Armonk, NY (US)

(72) Inventors: Yonghua Lin, Beijing (CN); Jianbin Tang, Melbourne (AU); Jun Song Wang, Beijing (CN); Qing Wang, Beijing (CN)

(73) Assignee: INTERNATIONAL BUSINESS MACHINES CORPORATION, Armonk, NY (US)

(21) Appl. No.: 14/224,306

(22) Filed: Mar. 25, 2014

(30) Foreign Application Priority Data
Mar. 29, 2013 (CN) 201310106874.0

(51) Int. Cl. H04L 5/00

(52) U.S. Cl. CPC H04L 5/0062
USPC 370/329

(57) ABSTRACT

A method and system for processing interference received by a wireless communication terminal. The method including: receiving interference information from the wireless communication terminal, wherein the interference information is used to identify an interfered sub-channel(s) of the wireless communication terminal; and adjusting a downlink resource allocated to the wireless communication terminal based on the interference information. The system including: a memory; a processor communicatively coupled to the memory; and a feature selection module communicatively coupled to the memory and the processor, wherein the feature selection module is configured to perform the steps of a method including: detecting interference received by a wireless communication terminal; identifying interfered sub-channel(s) of the terminal to obtain interference information of the terminal; and reporting interference information to a base station for the base station to adjust a downlink resource allocated to the terminal based on interference information.

### CROSS-REFERENCE TO RELATED APPLICATION

This application claims priority under 35 U.S.C. §119 from Chinese Patent Application No. 201310106874.0 filed Mar. 29, 2013, the entire contents of which are incorporated herein by reference.

### BACKGROUND OF THE INVENTION

1. Field of the Invention

The present invention relates to field of wireless communication, more specifically, to an interference processing method and system for a wireless communication terminal.

2. Description of the Related Art

In wireless communication networks, interference is a very important problem. Generally, interference includes internal interference and external interference. Internal interference is generally caused by the same wireless communication system in the neighbor cells, which can be avoided by adopting spectrum planning, such as, frequency reuse. External interference is caused by other unknown wireless communication systems, which can be very serious in some unauthorized or shared spectrum. Currently, some popular commercial standards, such as GSM, CDMA, LTE and WiMAX etc, only need to take internal interference into account, since they use dedicated authorized spectrum which will not be interfered by other systems. However, how to process external interference within unauthorized or shared spectrum is still an issue in academic and industrial fields.

### BRIEF SUMMARY OF THE INVENTION

The present invention provides a method for processing interference received by a wireless communication terminal. The method including: receiving interference information from the wireless communication terminal, wherein the interference information is detected by a physical layer of the wireless communication terminal and is reported to a base station, and is used to identify an interfered sub-channel(s) of the wireless communication terminal; and adjusting a downlink resource allocated to the wireless communication terminal based on the interference information.

According to another aspect of the present invention, there is provided an information processing system for processing interference received by a wireless communication terminal, the information processing system including: a memory; a processor communicatively coupled to the memory; and a feature selection module communicatively coupled to the memory and the processor, wherein the feature selection module is configured to perform the steps of a method including: detecting an interference received by a wireless communication terminal; identifying an interfered sub-channel(s) of the wireless communication terminal to obtain interference information of the wireless communication terminal; and reporting the interference information to a base station for the base station to adjust a downlink resource allocated to the wireless communication terminal based on the interference information.

According to another aspect of the present invention, there is provided an information processing system for processing interference received by a wireless communication terminal, the information processing system including: a memory; a processor communicatively coupled to the memory; and a feature selection module communicatively coupled to the memory and the processor, wherein the feature selection module is configured to perform the steps of a method including: receiving interference information from the wireless communication terminal, wherein the interference information is used to identify an interfered sub-channel(s) of the wireless communication terminal; and adjusting a downlink resource allocated to the wireless communication terminal based on the interference information.

### BRIEF DESCRIPTION OF THE DRAWINGS

Through the more detailed description of some embodiments of the present disclosure in the accompanying drawings, the above and other objects, features and advantages of the present invention will become more apparent, wherein the same reference generally refers to the same components in the embodiments of the present disclosure.

FIG. 1 shows a block diagram of an exemplary computer system/server which is applicable to implement the embodiments of the present invention.

FIG. 2 shows a flowchart of a method for processing interference received by a wireless communication terminal according to an embodiment of the present invention.

FIG. 3 shows a flowchart of a method for processing interference received by a wireless communication terminal according to an embodiment of the present invention.

FIG. 4 shows a diagram of an interference bitmap identifying interfered sub-channel(s) according to embodiments of the present invention.

FIG. 5 shows a diagram of an architecture that reports interference information via MAC layer according to an embodiment of the present invention.

FIG. 6 shows a diagram of an architecture that reports interference information via physical layer according to an embodiment of the present invention.

FIG. 7 shows a system for processing interference received by a wireless communication terminal according to an embodiment of the present invention.

FIG. 8 shows a system for processing interference received by a wireless communication terminal according to embodiments of the present invention.

### DETAILED DESCRIPTION OF THE PREFERRED EMBODIMENTS

In the present invention, although there are some known methods for processing interference at base station in the area, due to influence of various factors such as position, antenna height etc, interference at a base station is significantly different from interference at a terminal and interference received by each terminal will also be different. Processing of interference received by base station can not effectively avoid downlink interference, i.e., influence of interference received at a terminal. In the present invention, by using the terminal to detect its received interference and feeding the interference back to the base station, the base station can perform central processing based on the interference information uploaded by the terminal to effectively avoid interference received by the terminal.

The above aspects of the invention enable a base station to effectively avoid interference received by a terminal based on interference information uploaded by the terminal.

Some preferable embodiments will be described in more detail with reference to the accompanying drawings, in which the preferable embodiments of the present invention have been illustrated. However, the present invention can be implemented in various manners, and thus should not be construed to be limited to the embodiments disclosed herein. On the contrary, those embodiments are provided for the thorough and complete understanding of the present invention, and completely conveying the scope of the present invention to those skilled in the art.

As will be appreciated by one skilled in the art, aspects of the present invention can be embodied as a system, method, or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

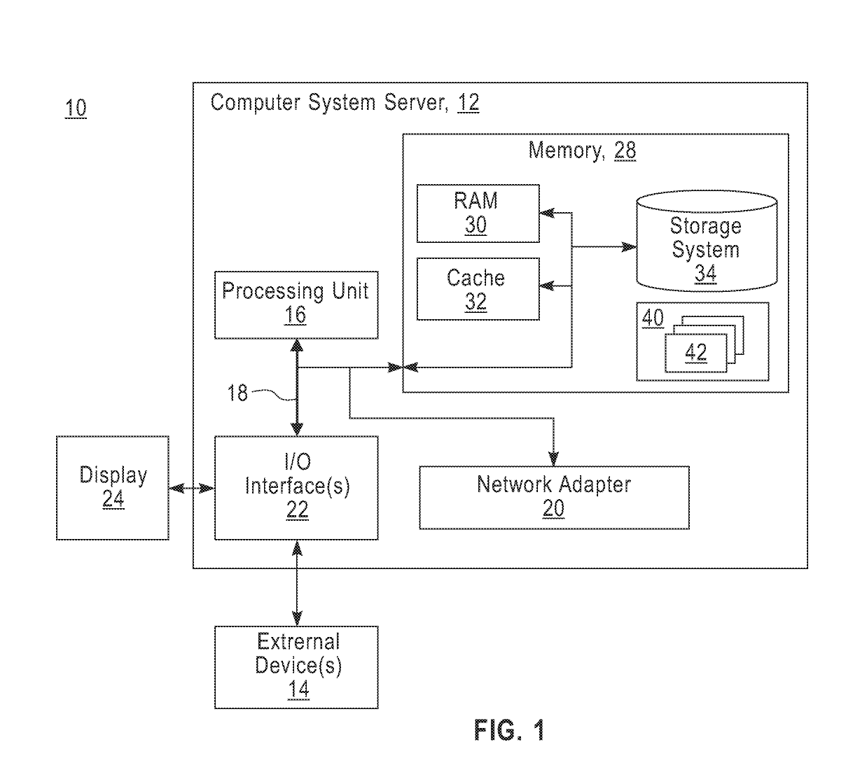

Referring now to FIG. 1, in which a block diagram of an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

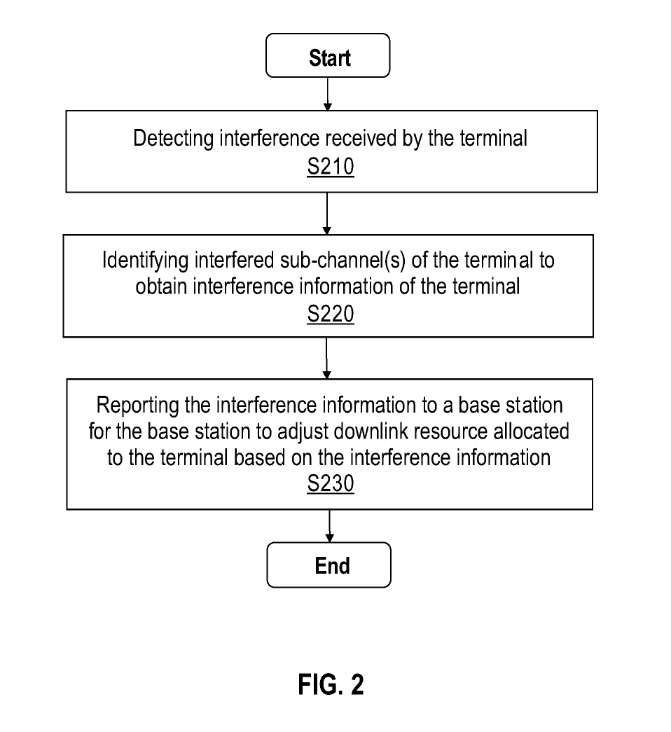

FIG. 2 shows a flowchart of a method for processing interference received by a wireless communication terminal according to an embodiment of the present invention.

According to the method, in step S210, detecting interference received by the terminal.

As mentioned above, due to influence of various factors such as position, antenna height etc, interference at a base station is significantly different from interference at a terminal and interference received by each terminal will also be different. In order to effectively process interference received by each wireless communication terminal, what is needed first is to detect interference received by each terminal.

Detection of interference can be performed via physical layer of a terminal. Physical layer of a terminal can detect interference around a terminal according to some signal detection methods.

According to an embodiment of the present invention, interference received by a terminal can be detected by detecting a preamble sequence received by the terminal.

Within each OFDM (Orthogonal Frequency Division Multiplexing) based wireless system standard, a preamble sequence is designed for terminal's time-frequency synchronization. Generally, these preamble sequences for synchronization will not occupy all sub-carriers, rather, they only occupy a portion thereof. For example, according to IEEE 802.16e standard, only ⅓rd of sub-carriers are occupied by preamble sequence, that is, only one sub-carrier is used to transmit preamble sequence among every 3 sub-carriers, and the other two sub-carriers remain unused. Thus, behaviour of signal received by the terminal in frequency domain is as follows: peak value occurs on sub-carrier with preamble sequence, and no peak value occurs on sub-carrier without preamble sequence, rather, there are just some noise. However, once peak value occurs on these sub-carriers, it means that interference occurs on these sub-carriers. It can be determined whether there is interference or not by comparing signal strength on sub-carrier. For example, usually, a signal requires certain SNR threshold to demodulate wireless signal, and in this case, ratio of signal strength on sub-carrier of its preamble sequence to signal strength on its adjacent null sub-carrier is detected, and it is considered that there is interference in the area if the ratio is less than the threshold. It should be noted that, the received preamble sequence can be detected by using any other manners known to those skilled in the art, so as to determine whether there is interference or not.

According to an embodiment of the present invention, interference at a terminal can also be detected by detecting channel response of the terminal. In case that there is no interference, channel response should be continuous and without sudden change, however, where there is interference, discontinuity will occur in channel response, for example, a spike will occur. In this case, interference received by the terminal can also be determined. For example, frequency domain channel estimation can be performed by using a pilot sequence, to estimate frequency domain response of channels within entire spectrum, channel response of that frequency domain should be smooth and continuous if there is no interference. However, abnormal peak value will occur if there is interference. Similarly, it should be noted that, channel response can be detected by using any other manners known to those skilled in the art, so as to determine whether there is interference or not.

Also, those skilled in the art will appreciate that, the invention is not limited to the interference detection method described herein as an example, there are many existing detection algorithms, such as energy detection used in cognitive radio, signal chrematistics based detection etc, and any method capable of detecting interference received by a terminal can be used in the invention to achieve the purpose of the invention.

In step S220, identifying interfered sub-channel(s) of the terminal to obtain interference information of the terminal.

Each terminal will be allocated thereto one or more sub-channels. In field of wireless communication, sub-channel is a concept of wireless standard and can be considered as a set of sub-carrier groups. For example, for IEEE 802.16e, in downlink AMC (Adaptive Modulation and Coding), every 27 continuous sub-carriers constitutes a sub-channel. With respect to current multiple carrier system having wider bandwidth, such as OFDMA (Orthogonal Frequency Division Multiple Access), the whole spectrum is divided into several sub-channels to facilitate flexible resource allocation. Thus, it can be identified within which sub-channel(s) is/are the interference received by the terminal located, so that by identifying the sub-channel, interference information of the terminal can be obtained.

According to an embodiment of the present invention, the interference information can be represented by a bitmap corresponding to each sub-channel, such as, 00001000 . . . 0010, wherein, “0” represents that corresponding sub-channel has not been interfered, and “1” represents that corresponding sub-channel has been interfered. For example, FIG. 4 shows a diagram of an interference bitmap identifying interfered sub-channel(s). Those skilled in the art should appreciated that, corresponding sub-channel can also be identified by using any other manners known to those skilled in the art, so as to represent the interference information.

In step S230, reporting the interference information to a base station for the base station to adjust downlink resource allocated to the terminal based on the interference information. For example, adjustment can be made by allocating as many interfered sub-channel(s) of the terminal as possible to other terminal, so as to avoid interference received by the terminal.

In this way, by detecting interference at a terminal and feeding interference information back to a base station, interference received by the terminal can be effectively alleviated or even avoided.

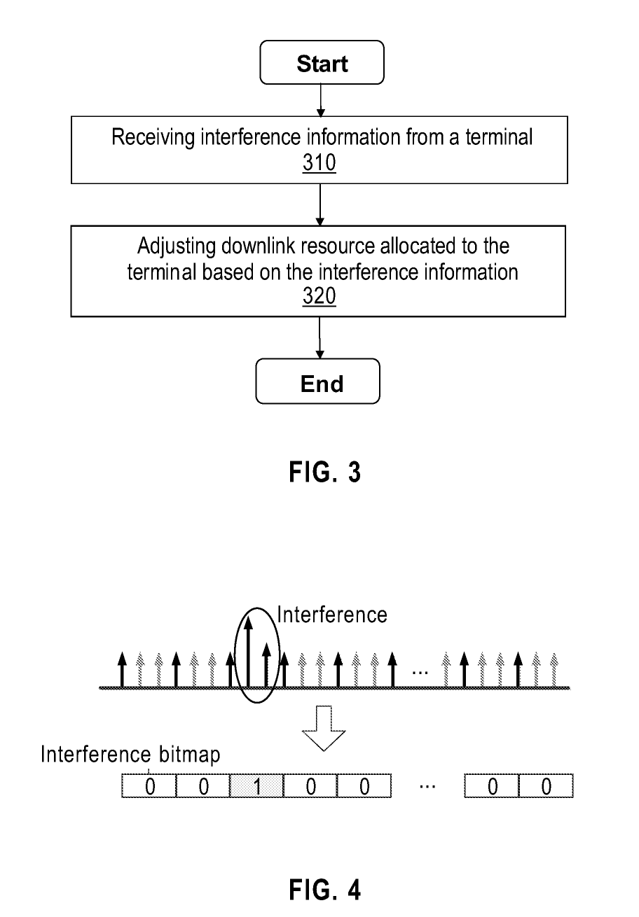

FIG. 3 shows a flowchart of a method for processing interference received by a wireless communication terminal according to another embodiment of the present invention. The method includes steps implemented at base station side.

In step S310, receiving interference information from at least one terminal, wherein the interference information is used to identify interfered sub-channel(s) of the at least one terminal.

According to an embodiment of the invention, interference can be detected by physical layer of a terminal by using any one of signal detection methods described above. Further, according to an embodiment of the present invention, interference information can be bitmap information corresponding to each sub-channel, and interfered sub-channel(s) of the terminal is/are identified by the bitmap information.

In step S320, adjusting downlink resource allocated to the at least one terminal based on the interference information.

The downlink resource is shared by all the terminals, and interference to a downlink channel is specific to a certain terminal. Thus, for a certain sub-channel, it has been interfered with respect to a certain terminal; however, it can be a relatively clean channel with respect to other terminals. Thus, when allocating downlink resource, a base station can allocate un-interfered sub-channels to corresponding terminals based on interference condition of respective terminals.

According to an embodiment of the present invention, when allocating downlink resource to a terminal, a resource scheduler in the base station first identifies interfered sub-channel(s) of the terminal based on interference information of the terminal, and adjusts downlink resource accordingly, so that when possible, not allocate the identified interfered sub-channel(s) to this terminal, thereby avoiding interference in downlink. Thus, when allocating resource to usual downlink control information, the resource scheduler can, when possible, allocate un-interfered sub-channels to all or most of terminals, so as to ensure that all or most of terminals can correctly decode downlink control information, which is very important and necessary for stability of the whole wireless network.

After interference has been detected by physical layer of the terminal, interference information can be reported to a base station in various manners. According to an embodiment of the present invention, interference information can be reported to the base station via a control message link of MAC (Media Access Control) layer of the terminal.

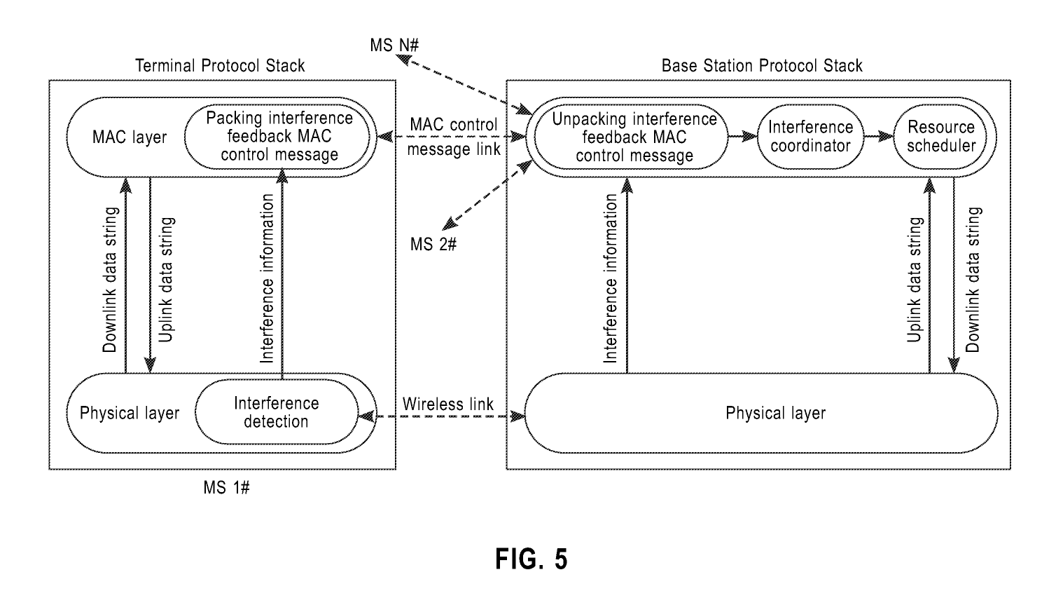

FIG. 5 shows a diagram of an architecture that reports interference information via MAC layer according to an embodiment of the present invention. MS 1#, MS 2#, MS N# represent different wireless communication terminals, respectively. Here, for brevity, only communication between MS 1# and base station is shown.

According to an embodiment of the present invention, physical layer of the base station detects interference around a terminal through interference detection, for example, after interference has been detected, first, the interference information can be reported to MAC layer of the terminal via an interface between MAC layer and physical layer. Once MAC layer receives this interference information, the interference information is packed into one piece of MAC control message, and like other MAC control messages, it is sent to MAC layer of the base station by using a control message link of MAC layer. At base station side, MAC layer of the base station obtains interference information of the terminal by unpacking that MAC control message, and an interference coordinator at MAC layer collects all downlink interference information of each terminal from an interference feedback channel, and sends them to the resource scheduler in a predetermined format.

Since all of existing wireless standards define a series of inter-MAC control messages, in this case, what is needed is to only define a new MAC control message on basis of an existing standard without changing normal MAC control scheme, thus this scheme can be compliant with most of existing standards and can be easily implemented.

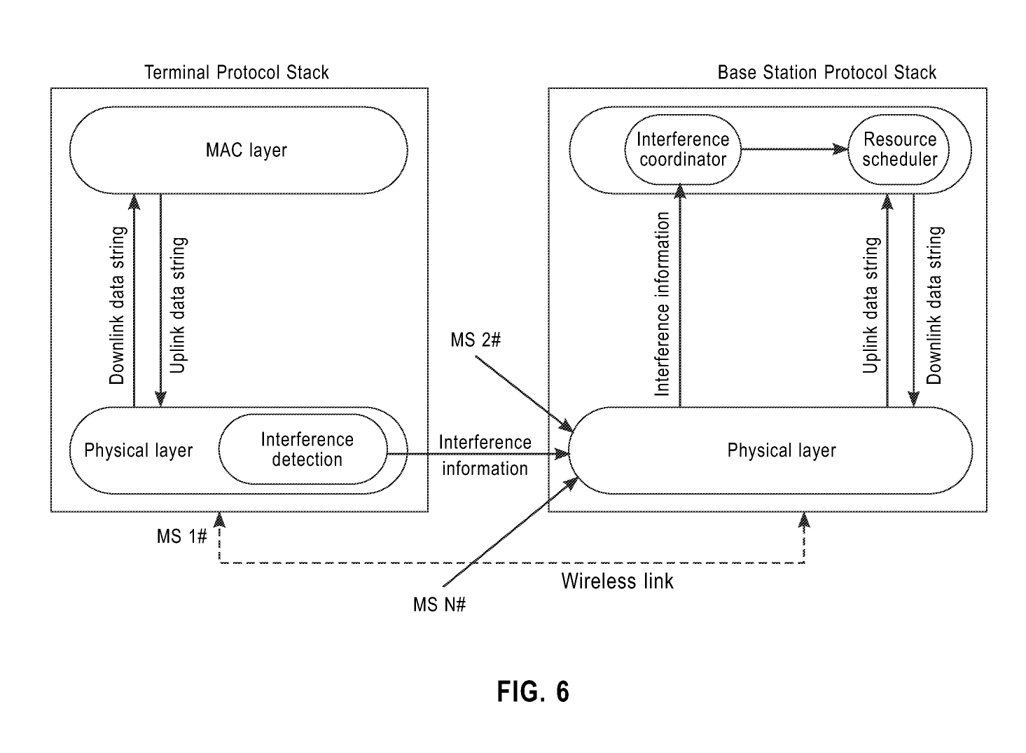

According to another embodiment of the invention, interference information can also be transmitted by using physical layer. FIG. 6 shows a diagram of an architecture that reports interference information via physical layer. Similarly, for brevity, only communication between one wireless mobile terminal and base station is shown.

Wireless communication standard generally will define a group of rapid feedback messages at physical layer, and allocate certain uplink resources for transmitting these messages, and these messages can be parsed by physical layer. Thus, the present invention can utilize these specific resources, and after interference is detected by physical layer, upload interference information to physical layer of base station via a rapid feedback channel of physical layer, and transmit the interference information to an interference coordinator via physical layer of base station. The interference coordinator collects all the downlink interference information of each terminal from an interference feedback channel, and transmits them to the resource scheduler in a predetermined format.

Taking IEEE 802.16e for example, it defines 16 types of data and control channels at physical layer for transmitting uplink traffic data and control signaling, wherein each control channel has special function, such as ranging channel, ARQ channel etc. According to an embodiment of the present invention, one channel can be added on the 16 channels for transmitting bitmap information of downlink interference, and the added channel can be implemented by base station in a Round-Robin Scheduling manner.

Rapid interference information feedback can be obtained by using rapid feedback message of physical layer.

With embodiments of the present invention, interference around a terminal can be fed back to base station, thereby optimizing downlink resource allocation and preventing the terminal from being interfered.

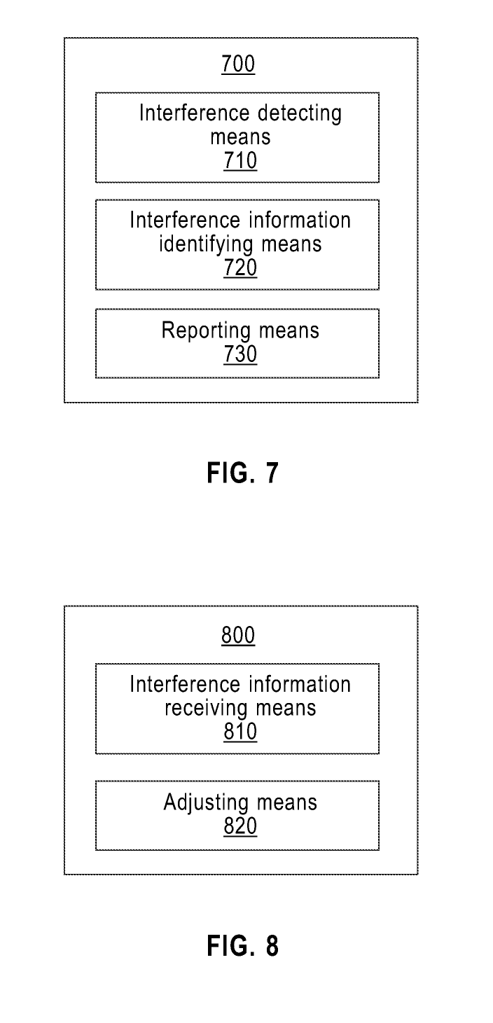

A system 700 implementing an embodiment of the present invention for processing interference received by a wireless communication terminal will be described below with reference to FIG. 7. The system 700 includes: an interference detecting means 710 configured to detect interference received by the terminal; an interference information identifying means 720 configured to identify interfered sub-channel(s) of the terminal to obtain interference information of the terminal; and a reporting means 730 configured to report the interference information to a base station for the base station to adjust downlink resource allocated to the terminal based on the interference information.

According to an embodiment of the invention, the reporting means 730 can report the interference information to the base station via a control message link of MAC layer of the terminal. Wherein, the reporting means 730 is further configured to transmit the interference information from physical layer of the terminal to MAC layer of the terminal via an interface between MAC layer and physical layer of the terminal and transmit the interference information to the base station via a control message link of the MAC layer.

According to an embodiment of the present invention, the reporting means 730 can report the interference information to the base station via a rapid feedback channel of physical layer of the terminal.

According to an embodiment of the present invention, the interference detecting means 710 detects interference received by the terminal by detecting a preamble sequence received by the terminal.

According to an embodiment of the present invention, the interference detecting means 710 detects interference received by the terminal by detecting channel response of the terminal.

A system 800 implementing an embodiment of the invention for processing interference received by a wireless communication terminal will be described below with reference to FIG. 8. The system 800 includes: an interference information receiving means 810 configured to receive interference information from the terminal, wherein the interference information is detected by physical layer of the terminal and is reported to a base station, and is used to identify interfered sub-channel(s) of the terminal; and an adjusting means 820 configured to adjust downlink resource allocated to the terminal based on the interference information.

According to an embodiment of the invention, the adjusting means 820 is further configured to identify interfered sub-channel(s) of the terminal based on the interference information and adjust downlink resource allocation so as to avoid allocating the identified sub-channel(s) to the terminal.

According to an embodiment of the present invention, the interference information receiving means 810 receives, from MAC layer of the terminal, interference information from the terminal via a control message link of the MAC layer.

According to an embodiment of the present invention, the interference information receiving means 810 receives, from physical layer of the terminal, interference information from the terminal via a rapid feedback channel of the physical layer.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for processing interference received by a wireless communication terminal, the method comprising:
receiving interference information from the wireless communication terminal, wherein the interference information is used to identify an interfered sub-channel(s) of the wireless communication terminal; and
adjusting a downlink resource allocated to the wireless communication terminal based on the interference information.

2. The method according to claim 1, wherein adjusting the downlink resource allocated to the wireless communication terminal based on the interference information comprises:
identifying the interfered sub-channel(s) of the wireless communication terminal based on the interference information; and
adjusting the downlink resource allocation so as to avoid allocating the interfered sub-channel(s) to the wireless communication terminal.

3. The method according to claim 1, wherein receiving the interference information from the wireless communication terminal comprises:
receiving, from an MAC layer of the wireless communication terminal, the interference information from the wireless communication terminal via a control message link of the MAC layer.

4. The method according to claim 1, wherein receiving the interference information from the wireless communication terminal comprises:
receiving, from a physical layer of the wireless communication terminal, the interference information from the wireless communication terminal via a rapid feedback channel of the physical layer.

5. The method according to claim 1, wherein the interference information is bitmap information corresponding to the wireless communication terminal.

6. The method according to claim 1, further comprising:
detecting an interference received by a wireless communication terminal;
identifying an interfered sub-channel(s) of the wireless communication terminal to obtain interference information of the wireless communication terminal; and
reporting the interference information to a base station for the base station to adjust a downlink resource allocated to the wireless communication terminal based on the interference information.

7. The method according to claim 6, wherein reporting the interference information to the base station comprises: reporting the interference information to the base station via a control message link of a MAC layer of the wireless communication terminal.

8. The method according to claim 7, wherein reporting the interference information to the base station via a control message link of the MAC layer of the wireless communication terminal further comprises:
transmitting the interference information from a physical layer of the wireless communication terminal to the MAC layer of the wireless communication terminal via an interface between the MAC layer and the physical layer of the wireless communication terminal; and
transmitting the interference information to the base station via a control message link of the MAC layer.

9. The method according to claim 6, wherein reporting the interference information to the base station comprises: reporting the interference information to the base station via a rapid feedback channel of a physical layer of the wireless communication terminal.

10. The method according to claim 6, wherein detecting the interference received by the wireless communication terminal further comprises: detecting interference received by the wireless communication terminal by detecting a preamble sequence received by the wireless communication terminal.

11. The method according to claim 6, wherein detecting the interference received by the wireless communication terminal further comprises: detecting interference received by the wireless communication terminal by detecting a channel response of the wireless communication terminal.

12. The method according to claim 6, wherein identifying the interfered sub-channel(s) of the wireless communication terminal to obtain the interference information of the wireless communication terminal comprises:
identifying an interfered sub-channel(s) of the wireless communication terminal by using a bitmap, wherein obtained interference information of the wireless communication terminal is bitmap information.

13. An information processing system for processing interference received by a wireless communication terminal, the information processing system comprising:
a memory;
a processor communicatively coupled to the memory; and
a feature selection module communicatively coupled to the memory and the processor, wherein the feature selection module is configured to perform the steps of a method comprising:
detecting an interference received by a wireless communication terminal;
identifying an interfered sub-channel(s) of the wireless communication terminal to obtain interference information of the wireless communication terminal; and
reporting the interference information to a base station for the base station to adjust a downlink resource allocated to the wireless communication terminal based on the interference information.

14. The system according to claim 13, wherein reporting the interference to the base station comprises: reporting the interference information to the base station via a control message link of a MAC layer of the wireless communication terminal.

15. The system according to claim 14, wherein:
reporting transmits the interference information from a physical layer of the wireless communication terminal to the MAC layer of the wireless communication terminal via an interface between the MAC layer and the physical layer of the wireless communication terminal; and
reporting transmits the interference information to the base station via a control message link of the MAC layer.

16. The system according to claim 13, wherein reporting the interference to the base station comprises: reporting the interference information to the base station via a rapid feedback channel of a physical layer of the wireless communication terminal.

17. The system according to claim 13, wherein detecting the interference comprises: detecting the interference received by the wireless communication terminal by detecting a preamble sequence received by the wireless communication terminal.

18. The system according to claim 13, wherein detecting the interference comprises: detecting the interference received by the wireless communication terminal by detecting a channel response of the wireless communication terminal.

19. An information processing system for processing interference received by a wireless communication terminal, the information processing system comprising:
a memory;
a processor communicatively coupled to the memory; and
a feature selection module communicatively coupled to the memory and the processor, wherein the feature selection module is configured to perform the steps of a method comprising:
receiving interference information from the wireless communication terminal, wherein the interference information is used to identify an interfered sub-channel(s) of the wireless communication terminal; and
adjusting a downlink resource allocated to the wireless communication terminal based on the interference information.

20. The system according to claim 19, wherein:
adjusting the downlink resource is configured to identify the interfered sub-channel(s) of the wireless communication terminal based on the interference information; and
adjusting the downlink resource adjusts the downlink resource allocation so as to avoid allocating the interfered sub-channel(s) to the wireless communication terminal.

21. The system according to claim 19, wherein receiving interference information comprises: receiving from a MAC layer of the wireless communication terminal, the interference information from the wireless communication terminal via a control message link of the MAC layer.

22. The system according to claim 19, wherein receiving interference information comprises: receiving, from a physical layer of the wireless communication terminal, the interference information from the wireless communication terminal via a rapid feedback channel of the physical layer.
